(19) United States
(12) Patent Application Publication
(10) Pub. No.: US 2025/0100079 A1
(43) Pub. Date: Mar. 27, 2025

(54) Method for Pretreating a Surface of a Workpiece

(71) Applicant: Bayerische Motoren Werke Aktiengesellschaft, Muenchen (DE)

(72) Inventors: Thomas FORSTNER, Shanghai (CN); Hans Julius LANGEHEINECKE, Weyarn (DE)

(21) Appl. No.: 18/727,241

(22) PCT Filed: Mar. 17, 2023
(86) PCT No.: PCT/EP2023/056912

§ 371 Date: Jul. 8, 2024

(30) Foreign Application Priority Data
Mar. 23, 2022 (DE) 10 2022 106 766.1

(51) Int. Cl. B23K 26/352; B23K 26/03; B23K 26/0622; B23K 26/70; B32B 37/12; B32B 38/00

(52) U.S. Cl. CPC B23K 26/352; B23K 26/032; B23K 26/0622; B23K 26/702; B32B 37/12; B32B 38/0008

(57) ABSTRACT

A method for pretreating a surface of a workpiece includes radiating an energy beam onto the surface to pretreat the surface; capturing electromagnetic radiation of the energy beam by a capture device, the capture device providing at least one electrical signal characterizing the captured electromagnetic radiation; and monitoring the at least one electrical signal.

### BACKGROUND AND SUMMARY

The present disclosure relates to a method for pretreating a surface of a workpiece for a joining method following the pretreating according to the preamble of patent claim 1.

EP 2 527 048 B1 discloses a coating method in which a mixture or a pure substance is provided. A method for photochemically treating a target site can be gathered as known from DE 603 02 901 T2. Furthermore, WO 2012/113787 A1 discloses a method for joining substrates, in which at least one joining surface of a substrate to be joined is pretreated in an oxygen low-pressure plasma before the actual joining. In addition, WO 2018/149574 A1 discloses a method for producing an adhesive bond between a first body and a second body.

An object of the present disclosure is to provide a method for pretreating a surface of a workpiece, with the result that the pretreating can be monitored in a particularly advantageous manner.

This object is achieved, according to the present disclosure, by a method having the features of the present disclosure. The present disclosure further relates to advantageous configurations of the method.

In the method according to the present disclosure for pretreating a surface of a workpiece, also referred to as a component part, for a joining method following the pretreating, in particular in terms of time, an energy beam is radiated onto the surface, that is to say applied, in particular such that the energy beam is incident on the surface, in particular directly, in order to pretreat the surface of the workpiece. The pretreating of the surface is also referred to as pretreatment and is a method that differs from a joining method for joining, that is to say connecting, the component part to a further element. This means that, during the pretreating, the workpiece is not joined, that is to say connected, to another element.

In order to now be able to monitor the pretreating in a particularly advantageous manner and consequently to be able to achieve, for example, a particularly high degree of process quality of the joining method downstream of the pretreating in terms of time, the present disclosure provides, while the energy beam is being radiated onto the surface and in particular is incident on the surface, in particular directly, for electromagnetic radiation to be captured by a capture device, in particular in at least one predefined or predefinable wavelength range. The capture device provides at least one electrical signal characterizing the electromagnetic radiation captured by the capture device. Therefore, the electrical signal is, for example, a measurement result which is obtained or generated, that is to say in particular results, from the capture device capturing the electromagnetic radiation. In particular as a result of the fact that the energy beam is radiated onto the surface, the electromagnetic radiation is reflected by the surface, for example, and/or the electromagnetic radiation, which is also simply referred to as radiation, results, for example, from the fact that the energy beam, which is also simply referred to as a beam, is radiated onto the surface and is therefore applied and therefore is incident on the surface, in particular directly. In particular, the electromagnetic radiation results from an interaction of the energy beam with the surface, wherein the interaction takes place as a result of the fact that the energy beam is radiated onto the surface, in particular directly, and therefore is incident on the surface, in particular directly. Again, in other words, energy is introduced into the component part or the surface by irradiating the surface with the energy beam, in particular with a specific, that is to say for example predefinable or predefined, first wavelength, which results in heat, for example. This heat of the component part ensures that further radiation is emitted, in particular at a second wavelength that differs from the first wavelength, and is accordingly the result of the interaction, with the result that the further radiation is the electromagnetic radiation that is captured by the capture device. In addition to the generated radiation described here, in particular thermal radiation, it may be alternatively or additionally the case that the energy beam, for example in the form of a laser beam, is not coupled into the workpiece, accordingly does not result in the development of heat and does not change the surface. It is then obvious that the radiation which has not been coupled in is simply reflected away, which can likewise be detected by or in the method according to the present disclosure.

In the method according to the present disclosure, provision is also made for the pretreating to be monitored, in particular checked, by an evaluation device on the basis of the electrical signal. For this purpose, provision is made, in particular, for the evaluation device to receive the electrical signal. Since the electromagnetic radiation is captured by the capture device while the energy beam is being radiated onto the surface, that is to say applied, and the surface is therefore pretreated, the method according to the present disclosure makes it possible to monitor the pretreatment, which is also referred to as process monitoring, in particular in real time or online. As a result, the monitoring of the pretreatment is integrated into the actual pretreatment since the pretreatment and the monitoring of the pretreatment take place at the same time. The method according to the present disclosure makes it possible, in particular, to determine a process quality (first quality) of the pretreatment and, for example, also a product quality (second quality) of the component part (workpiece) having the pretreated surface, in particular by the monitoring, and to provide corresponding feedback on the status of the respective quality. This feedback can be used as a basis for controlling the process, that is to say the pretreatment, in order to carry out the pretreatment as desired, that is to say as an “in-order process”.

The method according to the present disclosure is based, in particular, on the following knowledge and considerations: in order to be able to meet high quality requirements in terms of a joint, for example an adhesive bond, in particular a high degree of quality of a process during which joints, for example adhesive bonds, are produced, for example during series production, a pretreatment of surfaces of workpieces, which is upstream of the production of the joint in terms of time, may be advantageous, which workpieces are connected and therefore joined to respective joining partners after the pretreatment via the surfaces. Since the workpiece is joined and therefore connected to a further element after the pretreatment via the pretreated surface, for example, the surface is also referred to as a joining surface. It has been found that a condition of the joining surface, which has the condition immediately before and during the connection to the further element, for example, is directly correlated to a quality of the produced joint, in particular. The method according to the present disclosure makes it possible to integrate the monitoring of the pretreating into the pretreating of the surface per se, with the result that the pretreating can be implemented quickly and in a cost-effective manner. The method according to the present disclosure can therefore be integrated in a particularly advantageous manner into series or mass production, during which the workpiece is joined, for example, wherein the method is scalable to other, subsequent joining and coating and other methods. A joinability in line with requirements or a resulting connection strength is greatly dependent on a condition of the surface of the workpiece to be joined, in particular with respect to a topography and a chemical condition of the surface, that is to say in particular with regard to a roughness and chemical constituents which promote joinability or wettability. The phenomenon of adhesion and cohesion, as used in adhesive bonding, is an area that has not been completely explored, that is to say the explanation of what promotes adhesion and cohesion still appears to be part of other research. This condition, which is also referred to as the surface condition, is modified or ensured or is intended to be modified or ensured by virtue of the pretreating with the aid of the energy beam, wherein a desired joining result can usually be achieved when, and only when, the pretreatment is carried out as desired or specified and consequently results in a desired or specified condition of the surface. Therefore, it is advantageous to monitor the pretreatment since the monitoring makes it possible to determine whether the pretreatment is carried out as desired or specified or differs from a desired or specified performance. In particular, the latter can finally lead to undesirable properties and therefore to an insufficient or insufficiently strong joint. Monitoring the pretreatment therefore enables a statement about a condition or a quality and therefore a result of the pretreatment and can therefore consequently spare a risky join or connection since, for example when the monitoring of the pretreatment determines that the pretreatment is or has not been carried out as desired or specified, it is possible to dispense with subsequent connection of the workpiece. This makes it possible to avoid excessive rejects in the downstream joining, which is also referred to as the joining process. In particular, the method according to the present disclosure makes it possible to not only classify or categorize the surface as good or poor after the pretreatment, but generally to show differences in the pretreatment result. The cause of the respective deviation of the pretreatment quality could likewise be shown with the aid of the method according to the present disclosure. In addition, a destructive part of quality controls can thus be reduced in comparison with conventional solutions, which can entail a significant minimization of costs. For example, the joining method comprises a welding and/or soldering method, for example with the aid of a laser beam, under protective gas, resistance welding etc., with the result that the method according to the present disclosure is suitable for at least virtually any joining method.

In order to be able to monitor the pretreatment in a particularly advantageous manner and therefore ensure a particularly high degree of process quality of the subsequent joining method, one embodiment of the method of the present disclosure provides for the electrical signal to be compared, as the actual signal, with an in particular predefinable or predefined target signal by the evaluation device. In addition, the pretreating is monitored by the evaluation device on the basis of the comparison of the actual signal with the target signal. The actual signal is formed by actual data, for example. The target signal is formed by target data, for example. The actual data are therefore compared with the target data, for example. The pretreating can be monitored in a precise and meaningful manner on the basis of this comparison. For example, when the actual signal or the actual data deviate(s) from the target signal or target data, in particular in such a manner that a deviation of the actual signal, in particular the actual data, from the target signal, in particular the target data, exceeds the predefinable or predefined threshold value, it can be concluded that the pretreatment is or was not carried out as desired or specified, with the result that an undesirable or insufficient quality or condition of the surface consequently results from the pretreating of the surface; otherwise, that is to say when the actual signal does not deviate from the target signal or when any deviation of the actual signal from the target signal is less than or equal to the threshold value, it can be concluded that the pretreatment was carried out as specified or desired and consequently, as a result of the pretreatment, the surface has an advantageous, sufficient condition which consequently results in the workpiece being able to be connected to a further element as desired or specified, in particular via the pretreated surface.

In order to be able to monitor the pretreatment in a particularly advantageous manner, a further configuration of the method according to the present disclosure provides for at least one warning signal that can be haptically and/or optically and/or acoustically perceived by a person and therefore by a human to be output, in particular to an environment of a playback device, by the playback device if any deviation of the actual signal from the target signal exceeds the threshold value.

A further embodiment is distinguished by the fact that a frequency, also referred to as the capture frequency, at which the electromagnetic radiation is captured by the capture device and is at least temporarily stored, in particular in an in particular electrical or electronic memory, for example the capture device, is at least one kilohertz, in particular at least 10 kilohertz and very particularly at least 20 kilohertz. Very preferably, the capture frequency is at least 30 kilohertz, in particular at least 50 kilohertz and very particularly at least 100 kilohertz. Very preferably, the capture device may operate at at least or precisely 250 kHz. This makes it possible to capture the electromagnetic radiation with a particularly high resolution, and so the pretreatment can be monitored in an extremely precise manner and checked in a meaningful manner.

It has been found to be furthermore particularly advantageous if the energy beam for pretreating the surface is radiated onto the surface and is therefore applied in a pulsed manner, with the result that, in particular, individual pulses of the energy beam which therefore follow one another in terms of time and in particular are spaced apart from one another in terms of time are applied to the surface. The energy beam, and therefore the pulses, therefore is/are incident on the surface, in particular directly. This makes it possible to achieve a high degree of process quality of the pretreatment per se, with the result that a particularly high degree of process reliability of the subsequent joining method can also be ensured.

It has been found to be particularly advantageous if a frequency, also referred to as the pulse frequency, at which the energy beam is radiated onto the surface in a pulsed manner is at least 1 kHz, in particular at least 10 kHz and very particularly at least 20 kHz. In particular, the pulse frequency is, for example, at least 30 kHz, in particular at least 50 kHz and at least or precisely 100 kHz. This makes it possible to pretreat the surface in a particularly advantageous manner, thus enabling a particularly high degree of process reliability. In particular, using a high pulse frequency makes it possible to carry out the pretreatment as a short-pulsed energy beam before the joining method, also referred to as the joining process, in order to also be able to meet particularly high quality standards.

In order to be able to monitor the pretreatment in a particularly precise manner, a further configuration of the method according to the present disclosure provides for the electromagnetic radiation to be captured by a first sensor of the capture device in a first wavelength range, and for the electromagnetic radiation to be captured by a second sensor of the capture device, which is provided in addition to the first sensor, in a second wavelength range that at least partially differs from the first wavelength range. Provision is therefore made, for example, for the first sensor to capture the electromagnetic radiation, and therefore electromagnetic waves, the respective wavelengths of which are in the first wavelength range. The second sensor captures electromagnetic radiation and therefore electromagnetic waves, the respective wavelengths of which are in the second wavelength range. The feature of the wavelength ranges at least partially differing from one another should be understood as meaning, in particular, the fact that, for example, respective first parts of the wavelength ranges overlap, but respective second parts of the wavelength ranges do not overlap. It is also conceivable for the wavelength ranges to be completely different from one another, with the result that the wavelength ranges do not overlap, but rather, for example, the first length range adjoins the second length range, in particular directly, or vice versa, or it is conceivable for the wavelength ranges to not overlap and for the wavelength ranges to be spaced apart from one another, with the result that there is a third wavelength range between the wavelength ranges, which third wavelength range does not belong to the first wavelength range or to the second wavelength range. The background of this embodiment is the knowledge that different wavelength ranges contain different information relating to the pretreatment and therefore that different information relating to the pretreatment can be obtained from the different wavelength ranges, and the pretreatment can therefore be monitored and in particular checked in a particularly precise manner. The capture device, which is also referred to as a sensor system, can therefore capture, that is to say detect, the electromagnetic radiation in different spectral ranges, in particular by the sensors. It is therefore possible to observe accurately defined spectra, in particular frequency spectra. This means that, for example, electromagnetic radiation in the visible range, thermal radiation in the infrared range, energy radiation reflected, in particular reflected back, by the surface in the spectrum of the energy beam and/or at least virtually any other, further, arbitrary spectrum can be detected by the capture device, in particular via the sensors, and can be converted, in particular, into the electrical signal. This is carried out in the following manner, for example: the respective sensor has a respective capture range, for example. The respective capture range of the respective sensor should be understood as meaning the fact that the respective sensor can capture electromagnetic radiation or electromagnetic waves, the wavelengths of which are in the respective capture range. It is conceivable for the capture ranges of the sensors to be identical. For example, the respective sensor is a photodiode. In order to now capture the electromagnetic radiation in the first wavelength range by the first sensor and the electromagnetic radiation in the second length range by the second sensor, a first optical filter is assigned to the first sensor, for example, and a second, in particular optical, filter, which is provided in particular in addition to the first filter, is assigned to the second sensor. The first filter has a first passband, for example, with the result that the first filter lets through, for example, in particular only, electromagnetic waves, the respective wavelengths of which are in the first transmission range, and electromagnetic waves, the wavelengths of which are outside the first passband, since they have been filtered by the first filter, wherein the first sensor, for example, can detect, in particular exclusively, the electromagnetic radiation via the first filter. The first sensor therefore receives only the electromagnetic radiation or the electromagnetic waves which is/are let through by the first filter. Accordingly, the second filter has a second passband, for example, with the result that the second filter lets through only those electromagnetic waves, the respective wavelengths of which are in the second passband, wherein the second filter, for example, does not let through but, in particular, filters out electromagnetic waves, the wavelengths of which are outside the second passband. The second sensor, for example, can detect, in particular exclusively or only, the electromagnetic radiation via the second filter. The first sensor therefore receives only the electromagnetic waves of the electromagnetic radiation that have been let through by the first filter, and the second sensor receives, for example, only the electromagnetic waves of the electrical radiation that have been let through by the second filter. The respective sensor may provide, for example, a respective electrical partial signal which characterizes the respective electromagnetic waves captured or detected by the respective sensor. The respective partial signal may be, for example, the aforementioned electrical signal which is provided by the capture device, or the partial signals are, for example, parts of the electrical signal provided by the capture device and form, for example, the electrical signal provided by the capture device. Therefore, for example, a first spectrum, in particular a first frequency spectrum, can be determined and consequently observed by the first sensor and a second spectrum, in particular a second frequency spectrum, can be determined and consequently observed by the second sensor in order to therefore obtain advantageous, in particular different, information relating to the pretreatment. The method according to the present disclosure therefore enables, in particular, spectrally specific, in particular high-resolution, monitoring of the pretreatment. In particular, the first passband is smaller than the first capture range and very particularly the second passband is smaller than the second capture range, thus making it possible to carry out particularly advantageous optical filtering.

In particular, the respective, in particular optical, filter is a physical filter and therefore a physically present component part, wherein the respective sensor, for example, captures the electromagnetic radiation via the respective filter, that is to say through the respective filter.

One advantageous design of the processes of optically filtering the electromagnetic radiation enables an exact correlation between a desired result, also referred to as the target result, of the pretreatment and a real result, also referred to as the actual result, of the pretreatment. As a result of the fact that the pretreatment is, for example, a short-pulsed laser process, in particular with a high repetition rate, an above-average data acquisition rate, in particular in a medium kHz range, in the method can be used, for example makes it possible, to observe and in particular monitor and analyze each individual resulting processing point, at which the respective individual pulse is incident or has been incident on the surface. Each pulse which is incident on the surface causes a respective signal or a part of the radiation which is captured by the capture device, wherein the respective signal or the respective part can be accordingly analyzed. On the basis of obtained information, in particular relating to a signal length, a signal intensity or amplitude, and a signal curve profile, an exact statement on a quality of the pretreatment and/or a characteristic of the pretreated surface can be made, in particular taking into account various spectral ranges and positioning of the sensor system. A high resolution possibility of the method may involve detecting the finest power variations in the energy beam, changes in the working distance, a change in focus, a change in frequency, a geometric change in the component part (edges, soldered seams, welded seams, indentations, holes, etc.), surface irregularities (oil, scratches, loop and hook tears, roughnesses, impurities and/or residues of previous processes, etc., for example release agents during material production, washing substances during a washing process, surrounding materials (dust, oil, etc.) during storage), changes in the material properties (alloy constituents etc.), in particular in real time, and, if necessary, outputting a categorization, for example the aforementioned warning signal.

It is conceivable for the workpiece to be formed on a metal material. However, the workpiece is not restricted to a metal material, and so it is conceivable for the workpiece to be able to be formed from a material other than a metal material, for example from a plastic.

In principle, it is conceivable for an electron beam or another energy beam to be used as the energy beam.

However, it has been found to be particularly advantageous if a laser beam is used as the energy beam in order to thereby be able to achieve a particularly high degree of process quality.

A further embodiment is distinguished by the fact that, after the surface has been pretreated, the workpiece is joined to at least one further component by the joining method following the pretreating in terms of time by connecting the workpiece to the further component, in particular directly, via the pretreated surface. For this purpose, the pretreated surface, for example, is connected and therefore joined, in particular directly, to the further component, that is to say a further surface of the further component. This makes it possible to achieve a particularly high degree of quality of the joining method.

Finally, in order to achieve a particularly high degree of process quality, it has been found to be advantageous if the workpiece is adhesively bonded to the further component, in particular directly, via the pretreated surface and is thereby connected to the further component. This is carried out, in particular, by applying an adhesive to the pretreated surface, in particular directly, and/or arranging it on the surface and therefore between the surfaces, for example, with the result that the adhesive directly touches the pretreated surface, for example.

Further details of the present disclosure emerge from the following description of preferred exemplary embodiments with the associated drawings.

### BRIEF DESCRIPTION OF THE DRAWINGS

FIG. 1 shows a schematic perspective view of an apparatus for carrying out a method for pretreating a surface of a workpiece for a joining method following the pretreating;

FIG. 2 shows a graph for illustrating the method;

FIG. 3 shows a graph for further illustrating the method.

In the figures, identical or functionally identical elements are provided with the same reference signs.

### DETAILED DESCRIPTION OF THE DRAWINGS

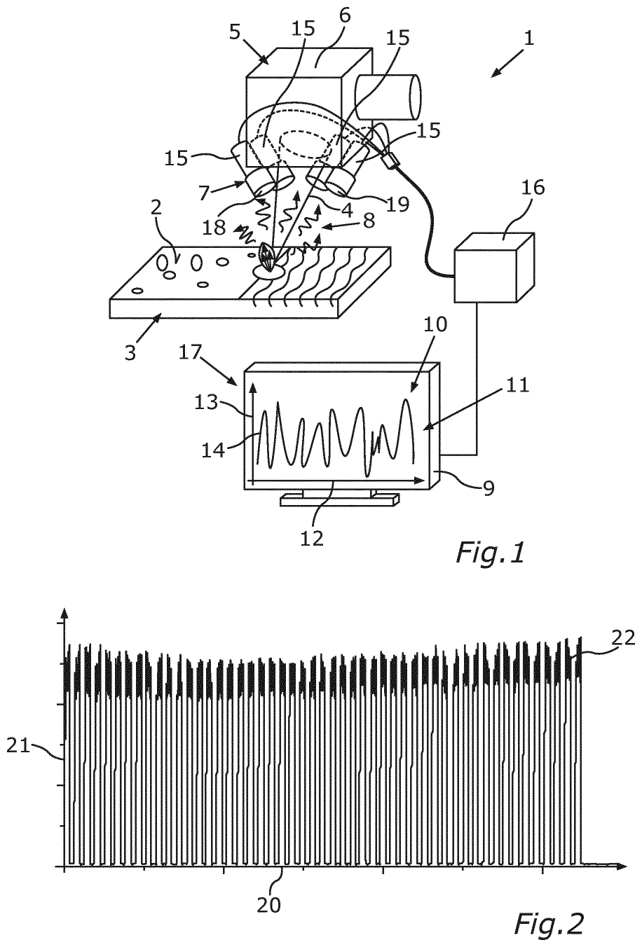

FIG. 1 shows a schematic illustration of an apparatus 1 which, as explained in yet more detail below, can be used for a method for pretreating a surface 2 of a workpiece 3, which is referred to as a component part or is in the form of a component part, for a joining method following the pretreating, which is also referred to as pretreatment or a pretreatment process, in particular in terms of time. In the method, in order to pretreat the surface 2, an energy beam, which is in the form of a laser beam 4 in the exemplary embodiment shown in the figures, is radiated onto the surface 2, in particular directly, by a radiation source in the form of a laser 5 in the present case and is therefore applied to the surface. For this purpose, the laser 5 comprises a scanning head 6 which is simply also referred to as a head or scanning system and is also referred to as a scan head or scanner. The laser beam 4 is radiated onto the surface 2, in particular directly, at different locations of the surface 2 by the scanning head 6. In other words, the laser beam 4 is radiated and therefore applied, in particular directly, onto the respective different locations of the surface 2, in particular in succession, by the scanning head 6, with the result that the laser beam is incident, in particular directly, on the different locations and therefore on the surface 2, in particular in succession. For example, the laser 5, in particular the scanning head 6, comprises at least one or more mirrors, via which the laser beam 4 is moved on or along the surface 2 which is also referred to as the component part surface.

The pretreating of the surface 2, which is also referred to as pretreatment, is used, for example, to carry out a surface modification and/or surface functionalization of the surface 2, that is to say to modify and/or functionalize the surface 2. For example, only dirt or impurities is/are simply removed from the surface 2 by the pretreating. It is also conceivable for the surface to serve a defined purpose or perform a defined function, in particular after the pretreating. The joining method follows the pretreatment of the surface 2, which is also referred to as surface pretreatment, in terms of time, with the result that the surface 2 is initially pretreated and then, that is to say in particular after the pretreatment has been fully completed, the component part 3 is joined and therefore connected to a further element in or by the joining method. This is carried out, for example, in such a manner that, after the surface 2 has been pretreated, the workpiece is joined, that is to say connected, to the further component part by the joining method following the pretreating in terms of time by connecting and therefore joining the workpiece 3 to the further component, in particular directly, via the pretreated surface 2. For this purpose, for example, the surface 2 is connected, in particular directly, to a further surface of the further component. This can be carried out, in particular, in such a manner that the workpiece 3 is adhesively bonded to the further component, in particular directly, via the pretreated surface 2 and is thereby joined, that is to say connected, to the further component, in particular directly. For this purpose, an adhesive, for example, is arranged between the pretreated surface 2 and the further surface of the component, in particular in such a manner that the adhesive directly touches at least the pretreated surface 2 and, for example, also the further surface of the further component. The workpiece 3 is adhesively bonded to the further component, in particular the further surface of the component, in particular directly, via the pretreated surface 2 by the adhesive.

In order to now be able to monitor the pretreatment in a particularly precise manner, with the result that a particularly high degree of process reliability of the joining method can consequently be achieved, in particular when the joining method is used, for example, during series or mass production, electromagnetic radiation 8 is captured by a capture device 7 of the apparatus 1 while the laser beam 4 is being radiated onto the surface 2 during the pretreating. The capture device 7 provides at least one electrical signal which characterizes the electromagnetic radiation 8 captured by the capture device 7 and is transmitted to an evaluation device 9 of the apparatus 1 and is received by the evaluation device 9. The pretreatment is monitored by the evaluation device 9 on the basis of the at least one electrical signal. It can be seen from FIG. 1 that the apparatus 1, in particular the evaluation device 9 which is also referred to as the evaluation device, has an electronic display 10 which is also referred to as a screen. A graph 11 having an abscissa 12 and an ordinate 13 and a profile 14 is displayed, for example, on the electronic display 10, wherein the profile 14 is the electrical signal, for example, or illustrates the electrical signal. In particular, the electrical signal comprises data or values also referred to as measured values, wherein the data or the measured values characterize the electromagnetic radiation 8 captured by the capture device 7. For example, the measured values form the profile 14 and the profile 14 comprises the measured values and the profile 14 illustrates the measured values.

The electrical signal or the measured values is/are compared, as an actual signal or as actual values, with a target signal or with target values, for example, by the evaluation device 9, wherein the pretreating is monitored by the evaluation device 9 on the basis of the comparison of the actual signal or the actual measured values with the target signal or the target measured values. In this respect, it is conceivable, in particular, for the signal to comprise the data or the measured values or for the data or measured values to form the signal.

The capture device 7 comprises, for example, collection elements 15 which are also referred to as focusing units or collecting units and are used to collect the electromagnetic radiation 8, for example. Furthermore, the capture device 7 may have, for example, a sensor element, in particular for each collection element 15, wherein the respective sensor element is in the form of a photodiode, which is simply also referred to as a diode, for example. The capture device 7 may have a housing 16 which is also referred to as an enclosure and in which the sensor elements (diodes) are arranged, for example. The respective electromagnetic radiation 8 collected and therefore captured by the respective collection element 15 is transmitted, for example, to the respective sensor element belonging to the respective collection element 15, and/or the respective electromagnetic radiation 8 collected and therefore captured by the respective collection element 15 is captured and/or evaluated by the respective sensor element belonging to the respective collection element 15, with the result that the capture device 7 consequently provides the at least one electrical signal which characterizes the captured electromagnetic radiation 8. The respective sensor element is therefore a respective sensor, for example, or the respective sensor element is also referred to as a respective sensor.

For example, an optically or acoustically perceptible warning signal is output, for example, by a playback device 17 of the apparatus 1 if a deviation of the actual signal or the actual measured values from the target signal or the target measured values exceeds an in particular predefinable threshold value. For example, the warning signal is displayed and therefore optically output on the electronic display 10. In particular, it is possible to likewise indicate, in particular output, a cause of the deviation on account of a high resolution of the method and in particular to output it by the playback device 17, in particular in such a manner that the warning signal and/or a further signal is/are displayed on the display 10 and characterize(s), in particular indicate(s) or illustrate(s), the cause.

In order to be able to monitor and in particular check the pretreatment in a particularly precise and meaningful manner, the following is provided, in particular. A first of the sensors captures, for example, only first electromagnetic waves of the electromagnetic radiation 8, wherein the first electromagnetic waves have respective wavelengths which are in a first wavelength range. It is conceivable for the first sensor to have a first capture range, with the result that the first sensor can fundamentally receive electromagnetic waves, the respective wavelengths of which are in the first capture range that is greater than the first wave range. However, in the method, provision is preferably made for the first sensor to capture only the mentioned first electromagnetic waves, the respective wavelengths of which are in the first wavelength range. This is achieved, in particular, by assigning a first transmission element to the first sensor, which transmission element is, for example, in the form of a physical, that is to say physically present, optical first filter 18 or a first diaphragm. For example, the first filter 18 is arranged in the housing 16 in which the first sensor is also arranged, for example. The first filter 18 is positioned precisely in front of the first sensor, for example. In other words, the first filter 18 is located precisely in front of the first sensor, for example. However, it is conceivable for the first filter 18, as shown in FIG. 1, to be arranged outside the housing 16 and, for example, in front of the collection element 15 belonging to the first sensor. At this location, it is possible to use, inter alia, the first diaphragm mentioned instead of an optical filter, for example the filter 18, which filters wavelengths. This first diaphragm lets through only a certain part of the radiation 8, based on its intensity, but not its wavelength. Each collection element 15 can therefore be individually adjusted by a diaphragm or a filter, for example. The orientation of the individual collection elements should likewise be taken into account. The significance of the process is likewise determined thereby. That is to say, the positioning and orientation of the focusing unit relative to the location at which the laser beam 4, in particular a respective laser beam pulse, is incident, are likewise an important point. With an optimum orientation, further information relating to the pretreatment process is obtained, for example the direction in which the laser beam is moved on the surface (for example in the +x or −x direction of the component part axis). The first diaphragm could be arranged, in particular, directly in front of the first sensor in the housing 16.

The first transmission element which is in the form of the first filter 18 in the present case lets through only the first electromagnetic waves of the electromagnetic radiation 8, wherein, as described above, the first electromagnetic waves of the electromagnetic radiation 8 have wavelengths which are in the first wavelength range. In other words, the first optical filter 18 lets only the first electromagnetic waves through it, the respective wavelengths of which are in a first passband of the first optical filter 18, wherein the first optical filter 18 filters all other electromagnetic waves, the respective wavelengths of which are outside the first passband, and therefore does not let them through to the first sensor. The first sensor captures the electromagnetic radiation 8 only, that is to say exclusively, via the assigned first optical filter 18, with the result that the first sensor captures only the first electromagnetic waves in the first wavelength range, that is to say only the first electromagnetic waves, the respective wavelengths of which are in the first wavelength range. The first wavelength range therefore corresponds to the first passband, and so the first sensor captures only the first electromagnetic waves which are let through by the first optical filter 18 assigned to the first sensor.

A second of the sensors captures only second electromagnetic waves of the electromagnetic radiation 8, wherein the second electromagnetic waves have wavelengths which are in a second wavelength range. The second sensor therefore captures only the second electromagnetic waves, the respective wavelengths of which are in the second wavelength range. The first wavelength range and the second wavelength range are at least partially, in particular completely, different from one another. For example, the second sensor has a second capture range, with the result that the second sensor can or could fundamentally capture electromagnetic waves, the respective wavelengths of which are in the second capture range, which is greater than the second wavelength range. However, the second sensor, for example, is assigned a second transmission element which is, for example, in the form of a physical, that is to say physically present, optical second filter 19 or in the form of a second diaphragm. The second sensor captures the electromagnetic radiation 8 only or exclusively via the second optical sensor 19 assigned to it. The second optical sensor 19 has a second passband that is smaller than the second capture range, with the result that the optical filter 19 lets only the second electromagnetic waves through it, the respective wavelengths of which are in the second passband of the second optical sensor 19. All other electromagnetic waves, the wavelengths of which are outside the second passband, are filtered by the second optical sensor 19 and therefore the second optical sensor 19 does not let them through, with the result that the first sensor receives and therefore captures only the first electromagnetic waves let through by the first optical filter 18 assigned to it and the second sensor receives and therefore captures only the second electromagnetic waves let through by the second optical filter 19 assigned to it. The second passband therefore corresponds to the second length range which differs at least partially from the first length range. In summary, the following is therefore preferably provided: the first sensor per se, that is to say considered in isolation, is fundamentally designed and able to capture electromagnetic waves, the respective wavelengths of which are in the first capture range. Accordingly, the second sensor per se, that is to say considered in isolation, is fundamentally designed and therefore able to capture, that is to say detect, electromagnetic waves, the respective wavelengths of which are in the second capture range, wherein it is conceivable for the first capture range and the second capture range to be identical. The first sensor can capture the electromagnetic radiation 8 exclusively via the first optical filter 18 assigned to it, and the second sensor can capture the electromagnetic radiation 8 exclusively via the second optical filter 19 assigned to it. The first optical filter 18 has the first passband that is smaller than the first capture range, with the result that the optical filter 18 lets only the first electromagnetic waves through it and therefore lets them through or allows them to advance to the first sensor, wherein the first optical filter 18 does not let all other electromagnetic waves, the wavelengths of which are outside the first passband, through it and therefore does not let them through or allow them to advance to the first sensor. The second optical filter 19 has the second passband that is smaller than the second capture range, with the result that the optical filter 19 lets only the second electromagnetic waves through it and therefore lets them through or allows them to advance to the second sensor, wherein the second optical filter 19 does not let all other electromagnetic waves, the wavelengths of which are outside the second passband, through it and therefore does not let them through or allow them to advance to the second sensor. The respective passband may be smaller than the respective capture range. In particular, it may be fundamentally the case that the passband generally differs from the capture range in terms of the transmissibility of the radiation. The passband may be arbitrarily set by conventional, in particular optical filters. A plurality of filters may also be placed above one another in order to obtain the desired passband (for example filter 1 300-750 nm+filter 2 cut-off 600 nm; everything between 300 and 750 nm would then shine through the filters, apart from the 600 nm, which are not let through by the second filter). A further passband could let through everything above 750 nm and could no longer let through 1030 nm, for example (also a combination of two filters).

In particular, it is conceivable for the respective diode to be situated in the enclosure (housing 16). The capture device 7 comprises the collection elements 15. The collection elements 15 are, for example, small optical elements, or the collection elements 15 comprise small optical elements, wherein the optical elements may be the filters 18 and 19, for example, and wherein the optical elements trap the radiation 8 as it were and together direct it, for example via connected fiber-optic cables, starting from the individual collection elements 15, to a large fiber-optic cable which runs into the housing 16. In the housing, which is also referred to as a sensor box, the radiation 8 is then divided among the respective diodes again and, once filtered as desired, converted into an electrical signal.

Therefore, considered for the apparatus 1 overall and therefore for the method overall, the first sensor captures only the first electromagnetic waves and the second sensor captures only the second electromagnetic waves. Provision is made, in particular, for the first electromagnetic waves and the second electromagnetic waves to be electromagnetic waves and therefore parts of the electromagnetic radiation 8. Sensors, for example the sensors mentioned, can naturally also be operated without filters so that the entire wavelength spectrum that can be resolved by the respective diode would be obtained.

The electrical signal characterizes, for example, both the captured first electromagnetic waves and the captured second electromagnetic waves. The background is the fact that different information relating to the pretreatment can be obtained from different wavelength ranges, that is to say on the basis of electromagnetic waves, the wavelengths of which are in the different wavelength ranges, with the result that the pretreatment can be monitored and in particular checked in a precise and meaningful manner on the basis of the information.

The first wavelength range corresponds to a first spectral range of a spectrum of the electromagnetic radiation 8, wherein the radiation 8 and therefore its spectrum are captured by the capture device 7. The second wavelength range corresponds to a second spectral range of the spectrum of the electromagnetic radiation 8, which second spectral range differs, in particular, at least partially from the first spectral range. The signal mentioned therefore comprises the spectral ranges, or the signal characterizes the spectral ranges. It is therefore possible to monitor the pretreatment on the basis of the spectral ranges which differ, in particular, at least partially from one another, that is to say using or on the basis of the spectral ranges. Spectral-specific monitoring of the pretreatment is therefore possible.

In order to be able to monitor the pretreatment in a particularly precise manner, a frequency which is also referred to as the capture frequency and at which the electromagnetic radiation 8 is captured by the capture device 7 and is at least temporarily stored is, for example, at least 10 kilohertz, in particular at least 20 kilohertz and very particularly at least or precisely 30 kilohertz. The capture frequency is also referred to as the sampling rate or data capture frequency, at which information or electrical signals from the diodes, that is to say information or signals provided by the diodes and characterizing the captured radiation 8, is/are recorded and analyzed.

Furthermore, in the method, provision is preferably made for the laser beam 4 to be radiated onto the surface 2 in a pulsed manner in order to pretreat the surface 2, with the result that respective laser pulses of the laser beam 4, which are also simply referred to as pulses, are incident on the respective, aforementioned locations of the surface 2, in particular directly. A frequency which is also referred to as the pulse frequency and at which the laser beam 4 is radiated onto the surface 2 in a pulsed manner, and therefore the pulses are incident on the surface 2 at the locations, is preferably at least one kilohertz, in particular at least 10 kilohertz and very particularly at least or precisely 20 kilohertz. The pulse frequency of the laser 5 is also referred to as the repetition rate of the laser 5 or as the laser frequency and is a frequency at which a respective pulse is provided by the beam source.

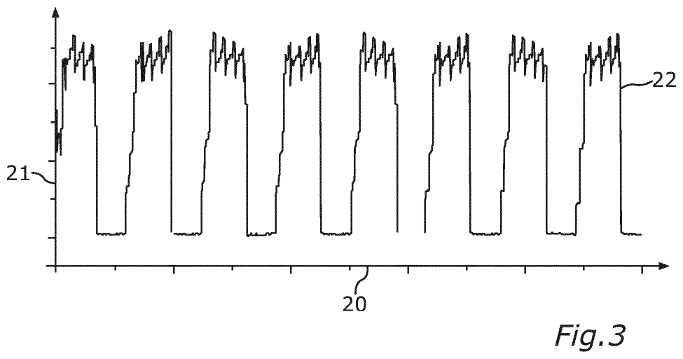

FIG. 2 shows a graph having an abscissa 20, an ordinate 21 and a profile 22 which is or illustrates, for example, the aforementioned electrical signal. The time is plotted on the abscissa 20 and values, for example, are plotted on the ordinate 21. FIG. 3 shows the graph according to FIG. 2, but in a greater resolution. It can be seen from FIG. 3 that the profile 22 has steps, which is the case, in particular, as a result of the fact that the profile 22 is an in particular digitally filtered profile or a digitally filtered signal, for example the aforementioned electrical signal. Each step of the profile 22 corresponds to one of the pulses that were incident on the surface 2. In other words, each step of the profile 22 illustrates one of the pulses which were incident on the surface 2. It is now possible to monitor the pretreatment in a particularly precise manner on the basis of the profile 22 and therefore on the basis of the electrical signal. In particular, the pretreatment can be monitored on the basis of a number of the steps and/or on the basis of a signal length and/or on the basis of different signal lengths. The respective signal length should be understood as meaning, in particular, an in particular temporal length of a respective amplitude of the signal or profile 22. In other words, the signal length which is referred to as the total signal length, that is to say the sum of all times, then corresponds to the process time for how long a process lasts. In particular, the temporal length of the amplitude correlates to a number of the measured values forming the amplitude.

In the exemplary embodiment shown in the figures, provision is therefore made for the collection elements 15, which are also referred to as optical focusing units or are in the form of optical focusing units, to be attached, in particular externally and/or laterally, to the scanning head 6, which is also referred to as the processing head, and to be accordingly aligned with a process zone in which the laser beam 4 is radiated onto the surface 2 and therefore is incident on it. Further decoupling variants which coaxially via a camera port of the processing head and a beam source switch itself are fundamentally possible, but hollow losses of the beam oxinate and therefore losses in the observation quality are produced thereby. In other words, the capture of the electromagnetic radiation 8 via the collection elements 15 outside the processing head is advantageous since the electromagnetic radiation 8 is not effected via an optical system, that is to say by circumventing an optical system which is in the form of a laser optical system in the present case and is used to radiate the laser beam 4 onto the surface 2. Again, in other words, the electromagnetic radiation 8 is captured by completely circumventing the optical system that is used to apply the laser beam 4 to the surface 2, as a result of which the electromagnetic radiation can be captured in a particularly advantageous manner and consequently the pretreatment can be monitored precisely. The electromagnetic radiation 8 emitted at different wavelengths during the pretreatment, in particular in the ongoing pretreatment, is guided by or via the focusing units to the sensor elements and is broken down into the respective spectral ranges in the sensor elements or by the sensor elements, in particular with the aid of the optical filters 18 and 19. The optical filters 18 and 19 and therefore the capture of the electromagnetic waves by the sensors or the sensor elements via the optical filters 18 and 19 therefore enable the above-described generation of the different spectral ranges which are, for example, constituents of the electrical signal or are formed or characterized by the electrical signal or form the electrical signal. For example, the electrical signal or the spectral ranges is/are recorded, in particular, by a data logger and, in particular, in the kilohertz range, that is to say is/are at least temporarily stored, in particular, in an electronic memory, for example of the evaluation unit 9. An in particular optical representation of the signal or of the spectra, in particular on the electronic display 10, and an evaluation of the signal or of the spectra, for example by an algorithm, are achieved. In particular, it is possible to categorize the signal or the spectra into different stages. It is therefore conceivable, in particular, for the evaluation unit 9 to monitor the pretreatment on the basis of the in particular different spectral ranges. The different spectra are displayed, for example, on the electronic display 10.

The respective spectral range is characterized, for example, by actual values and the respective spectral range, for example, is compared, as the actual spectral range, with a target spectral range or the actual values are compared with target values. If, for example, a deviation of the actual spectral range or of the actual values from the target spectral range or the target values is excessively large, with the result that the deviation exceeds an in particular predefinable or predefined limit value, a warning signal is output, for example. It can consequently be concluded that the pretreatment is or was not carried out as desired or specified, and so the subsequent joining method can be dispensed with, for example. In addition, a cause of the deviation can be inferred from the high resolution of the method.

It can be seen that the electromagnetic radiation 8 is effected during the actual pretreating for the two, however, and is therefore effected in real time and/or online, with the result that the method is particularly advantageous for mass or series production.

### LIST OF REFERENCE SIGNS

1 Apparatus
2 Surface
3 Workpiece
4 Laser beam
5 Laser
6 Scanning head
7 Capture device
8 Electromagnetic radiation
9 Evaluation device
10 Electronic display
11 Graph
12 Abscissa
13 Ordinate
14 Profile
15 Collection element
16 Housing
17 Playback device
18 First filter
19 Second filter
20 Abscissa
21 Ordinate
22 Profile

1-10. (canceled)

11. A method for pretreating a surface of a workpiece for joining following the pretreating, the method comprising:
radiating an energy beam onto the surface to pretreat the surface;
capturing electromagnetic radiation of the energy beam by a capture device, the capture device providing at least one electrical signal characterizing the captured electromagnetic radiation; and
monitoring, by an evaluation device, the pretreating based on the at least one electrical signal.

12. The method according to claim 11, comprising:
comparing, by the evaluation device, an actual signal with a target signal, the actual signal comprising the electrical signal or at least one evaluation signal generated from the electrical signal; and
monitoring the pretreating based on the comparing.

13. The method according to claim 12, comprising:
outputting at least one haptically and/or optically and/or acoustically perceptible warning signal by a playback device in response to a deviation of the actual signal from the target signal exceeding a threshold value.

14. The method according to claim 11, wherein a frequency at which the electromagnetic radiation is captured by the capture device and at least temporarily stored is at least 10 kHz.

15. The method according to claim 11, comprising:
radiating the energy beam onto the surface in a pulsed manner.

16. The method according to claim 15, comprising:
radiating the energy beam onto the surface in a pulsed manner at a frequency of at least 1 kHz.

17. The method according to claim 11, comprising:
capturing the electromagnetic radiation by a first sensor of the capture device in a first wavelength range; and
capturing the electromagnetic radiation by a second sensor of the capture device in a second wavelength range that at least partially differs from the first wavelength range.

18. The method according to claim 11, wherein the energy beam is a laser beam.

19. The method according to claim 11, comprising:
joining, after the pretreating the surface, the workpiece to at least one further component by connecting the workpiece to the at least one further component via the pretreated surface.

20. The method according to claim 19, wherein the connecting comprises adhesively bonding the workpiece to the at least one further component via the pretreated surface.

21. A pretreatment system for a surface of a workpiece, comprising:
a radiation emitter configured to radiate a beam of electromagnetic radiation onto the surface;
a detector configured to capture the electromagnetic radiation and provide an electrical signal characterizing the captured electromagnetic radiation; and
a monitor configured to evaluate the electrical signal.

22. The pretreatment system of claim 21, further comprising:
a playback device configured to output a warning signal in response to a deviation of an actual signal from a target signal exceeding a threshold value,
wherein the actual signal comprises the electrical signal or at least one evaluation signal generated form the electrical signal.

23. The pretreatment system of claim 21, wherein the detector is configured to: capture and at least temporarily store the electromagnetic radiation at a frequency of at least 10 kHz.

24. The pretreatment system of claim 21, wherein the radiation emitter is configured to radiate the beam of electromagnetic radiation in a pulsed manner.

25. The pretreatment system of claim 24, wherein the radiation emitter is configured to radiate the electromagnetic radiation in the pulsed manner at a frequency of at least 1 kHz.

26. The pretreatment system of claim 21, wherein the detector comprises:
a first sensor configured to capture the electromagnetic radiation in a first wavelength range; and
a second sensor configured to capture the electromagnetic radiation in a second wavelength range, the second wavelength range at least partially differing from the first wavelength range.

27. The pretreatment system of claim 21, wherein the beam is a laser beam.
